(19) United States
(12) Patent Application Publication
(10) Pub. No.: US 2003/0135634 A1
(43) Pub. Date: Jul. 17, 2003

(54) System and method for enhancing self-understanding, visualization, and motivation

(76) Inventors: Steven W. Moeller, Tustin, CA (US); Bruce J. Weinstock, Beverly Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/331,029

(22) Filed: Dec. 27, 2002

Related U.S. Application Data
(60) Provisional application No. 60/345,777, filed on Jan. 3, 2002.

(51) Int. Cl. G06F 15/16; G11B 27/00; H04N 5/93

(52) U.S. Cl. 709/231; 386/52

(57) ABSTRACT

A system and method for enhancing a person's self-understanding, visualization, and motivation are disclosed. One or more multimedia screens are displayed for the person to select as representing a preferred future. In response to the person's selections, additional multimedia screens are displayed for a person to select as representing possible aspects for the person's preferred future. As the person selects multimedia screens, the person builds a clear vision of his or her preferred future and becomes motivated to act to make the preferred future a reality.

### REFERENCE TO RELATED APPLICATION

The present application claims priority benefit under 35 U.S.C. §119(e) from U.S. Provisional Application No. 60/345,777, filed Jan. 3, 2002, entitled “System and Method for Enhancing Self-Understanding, Visualization, and Motivation,” which is incorporated herein by reference.

### FIELD OF THE INVENTION

The present invention relates to multimedia systems, and more particularly to a system and method for creating a multimedia presentation designed to enhance self-understanding, visualization, and motivation.

### BACKGROUND OF THE INVENTION

Each person has interests, opinions, attitudes, values, beliefs, and preferred lifestyle (collectively a “psychographic profile”). Aspects of a person's psychographic profile may be conscious or subconscious. Many persons have a self-understanding, which is an understanding of certain aspects of his or her psychographic profile. However, this conscious self-understanding is often incomplete and/or erroneous, given that there are often subconscious aspects to that person's psychographic profile. It follows that a person will make plans for his or her life and implement those plans with reference to this incomplete or erroneous self-understanding, and sometimes with no reference to this self-understanding. These plans fail to adequately align with the person's interests, opinions, attitudes, values, beliefs, and preferred lifestyle. Consequently, the person experiences a lower motivation to implement those plans, and the person may not successfully implement those plans. Additionally, even when the person successfully implements those plans, the results of the plans often fail to align with the person's interests, opinions, attitudes, values, beliefs, and preferred lifestyle. Thus, while expecting positive consequences from his or her plan, the person experiences neutral or negative consequences.

Embodiments of the present invention seek to overcome some or all of these and other problems.

### SUMMARY OF THE INVENTION

One aspect of a preferred embodiment of the invention is a multimedia system and method used to market financial products or services. The multimedia system is used to guide an investor through an interactive profiling experience, and to create a psychographic profile of the investor. The multimedia system is used to create a motivating multimedia presentation tailored to the conscious and subconscious aspects of that consumer's psychographic profile. The multimedia system is used to prepare a proposal tailored to that consumer's psychographic profile. Through experiencing the interactive profiling session, reviewing and editing the multimedia presentation, and reviewing the proposal, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, the investor emotionally connects with the vision of his or her preferred retirement that is provided by the multimedia presentation. Through assisting the investor, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. The focus of the financial advisor/investor discussion is not merely the financial products, but rather, the investor's self-understanding, preferred payoffs, and vision. With this client-centered approach, the financial advisor/investor relationship becomes a strong relationship based on confidence and trust. The investor is likely to refer the investor's friends to the financial advisor. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

One aspect of a preferred embodiment of the invention is a multimedia system and method used to clarify a person's conscious self-understanding and to create a motivating multimedia presentation tailored to the conscious and subconscious aspects of that person's psychographic profile. Guided by a clarified self-understanding and the vision of the person's preferred future provided by the multimedia presentation, the person assesses the potential benefits of a course of action. Consequently, the person is motivated to take appropriate action, according to that clarified self-understanding, to turn that vision into reality.

One aspect of a preferred embodiment of the invention is a multimedia system and method used to market products or services. The multimedia system is used to clarify a consumer's conscious self-understanding and to create a motivating multimedia presentation tailored to the conscious and subconscious aspects of that consumer's psychographic profile. Guided by a clarified self-understanding and the vision of the consumer's preferred future provided by the multimedia presentation, the consumer assesses the potential benefits of a marketer's products or services. Consequently, the consumer is motivated to purchase or use the appropriate products or services, according to that clarified self-understanding. Further, as a marketer becomes aware of the aspects of a person's self-understanding, the marketer can better advise the consumer as to what products or services would be appropriate for the consumer, according to that consumer's clarified self-understanding.

One aspect of a preferred embodiment of the invention is a multimedia system and method used to market financial products or services. The multimedia system is used to clarify an investor's conscious self-understanding and to create a motivating multimedia presentation tailored to the conscious and subconscious aspects of that investor's psychographic profile. Guided by a clarified self-understanding and the vision of the investor's preferred future provided by the multimedia presentation, the investor assesses the potential benefits of a financial advisor's products or services. Consequently, the investor is motivated to purchase or use the appropriate products or services, according to that clarified self-understanding. Further, as a financial advisor becomes aware of the aspects of a person's self-understanding, the financial advisor can better advise the investor as to what products or services would be appropriate for the investor, according to that investor's clarified self-understanding. The financial advisor/investor relationship, with this clarified self-understanding as its base, prospers as both the financial advisor and the investor share a clear vision of the investor's preferred future. In addition, with this shared vision, the likelihood increases that the financial advisor retains the investor as a long-term client.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

A general architecture that implements the various features of the invention will now be described with reference to the drawings. The following drawings and the associated description are provided to illustrate specific embodiments of the invention, and not to limit the scope of the invention.

FIG. 1 illustrates an embodiment of the invention wherein a retirement visualizer system is used to create a multimedia presentation.

FIG. 2 illustrates an embodiment of the invention wherein a process for creating a multimedia presentation is provided.

FIG. 3 illustrates an embodiment of the invention wherein a process for creating a psychographic profile is provided.

### DETAILED DESCRIPTION OF THE PREFERRED EMBODIMENT

For purposes of illustration, the system is described below in the context of a multimedia system. Throughout the description, reference is made to implementation-specific details. These details are provided to illustrate certain preferred embodiments of the invention, and not to limit the scope of the invention.

Visualization and Motivation

A person's psychographic profile may be used to determine or predict that person's behavior. A person's psychographic profile may be used to determine that person's wants or aspirations.

In one embodiment of the invention, a system is used to create a customized multimedia presentation designed to clarify a person's conscious self-understanding, and to motivate that person to act. As known by those skilled in the art, multimedia presentations may comprise one or more of many elements including, but not limited to, audio, video, text, and images. Through the selection of multimedia elements tailored to the conscious and subconscious aspects of a person's psychographic profile, the system is used to create and display a multimedia presentation that helps the person gain a clarified self-understanding. With this clarified self-understanding, the person gains a vision of how a certain course of action aligns with that self-understanding. With that clarified self-understanding and vision of the person's preferred future, the person assesses the potential benefits of that course of action. Consequently, the person is motivated to take appropriate action to turn that vision into reality. Further, as an advisor becomes aware of the aspects of a person's self-understanding, an advisor can better advise the person as to what course of action would be appropriate for the person, according to that person's clarified self-understanding.

Aspects of the system may be used with any suitable person, business, or endeavor.

For example only and not to limit the scope of the invention, aspects of the system may be used by multilevel marketers, travel agents, career counselors, coaches, and prisoner rehabilitators. Aspects of the system may be used by groups that want to share a common vision of their preferred future like charities, religious organizations, not-for-profit organizations, and corporations. Aspects of the system may be used by persons who want to envision, plan, and live his or her preferred life.

In another embodiment, aspects of the system may perform other suitable functions relating to creating a plan or implementing a plan. In another embodiment, aspects of the system may be combined with other systems to help to propose and to implement a plan for the person to turn his or her preferred future into reality.

For example only and not to limit the scope of the invention, in another embodiment, aspects of the system may be used to help a person perform prioritizing of daily tasks, or to help coach the person through a series of creative problem-solving exercises, until the person discovers an innovative solution to his or her problem. In another example, aspects of the system may be used to help a person visualize and implement a plan for having an ideal vacation. In another example, aspects of the system may be used to help a person visual implement a plan for achieving an ideal level of health or physical fitness.

Marketing Products and Services

In one embodiment of the invention, a multimedia system is used to market products or services. In this embodiment, the system is used to create a customized multimedia presentation designed to clarify a consumer's conscious self-understanding and motivate that consumer to act. Through the selection of multimedia elements tailored to the conscious and subconscious aspects of a consumer's psychographic profile, the system is used to create and display a multimedia presentation that helps the consumer gain a clarified self-understanding. With this clarified self-understanding, the consumer gains a vision of how certain products and services align with that self-understanding. With that clarified self-understanding and vision of the consumer's preferred future, the consumer assesses the potential benefits of those products or services. Consequently, the consumer is motivated to purchase-or use the appropriate products or services offered by the marketer. Further, as a marketer becomes aware of the aspects of a person's self-understanding, the marketer can better advise the consumer as to what products or services would be appropriate for the consumer, according to that consumer's clarified self-understanding.

Advising Investors Regarding Financial Products and Services

In one embodiment of the invention, a multimedia system is used to advise investors regarding financial products or services. In this embodiment, the system is used to create a customized multimedia presentation designed to clarify an investor's conscious self-understanding and motivate that investor to act. Through the selection of multimedia elements tailored to the conscious and subconscious aspects of an investor's psychographic profile, the system is used to create and display a multimedia presentation that helps the investor gain a clarified self-understanding. With this clarified self-understanding, the investor gains a vision of how certain financial products and services align with that self-understanding. With that clarified self-understanding and vision of the investor's preferred future, the investor assesses the potential benefits of those financial products or services. Consequently, the investor is motivated to purchase or use the appropriate financial products or services offered by the financial advisor. Further, as the financial advisor becomes aware of the aspects of the investor's self-understanding, the financial advisor can better advise the investor as to what products or services would be appropriate for the investor, according to that investor's clarified self-understanding.

The financial advisor/investor relationship, with this clarified self-understanding as its base, prospers as both the financial advisor and the investor share a clear vision of the investor's preferred future. In addition, with this shared vision, the likelihood increases that the financial advisor retains the investor as a long-term client.

Retirement Visualizer System

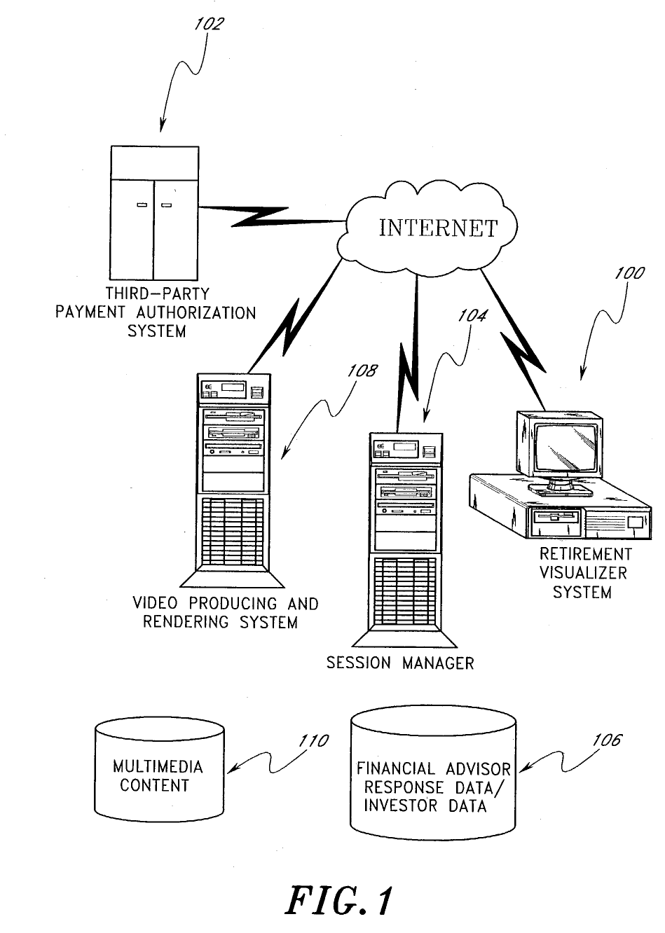

In one embodiment of the invention, as shown in FIG. 1, a retirement visualizer system 100 is a computer system connected to the Internet through a connection. A third-party payment authorization system 102 is a computer system connected to the Internet through a connection. A session manager 104 is a computer system connected to the Internet through a connection. A source of financial advisor response data and investor data 106 is provided using a database or other suitable storage device. A video producing and rendering system 108 is a computer system. The video producing and rendering system 108 is connected to the Internet through a connection. A source of multimedia content 110 is provided using a database or other suitable storage device. As is known by those skilled in the art, Internet connections may be wired or wireless. In another embodiment (not shown), the computer systems are connected via any suitable connection.

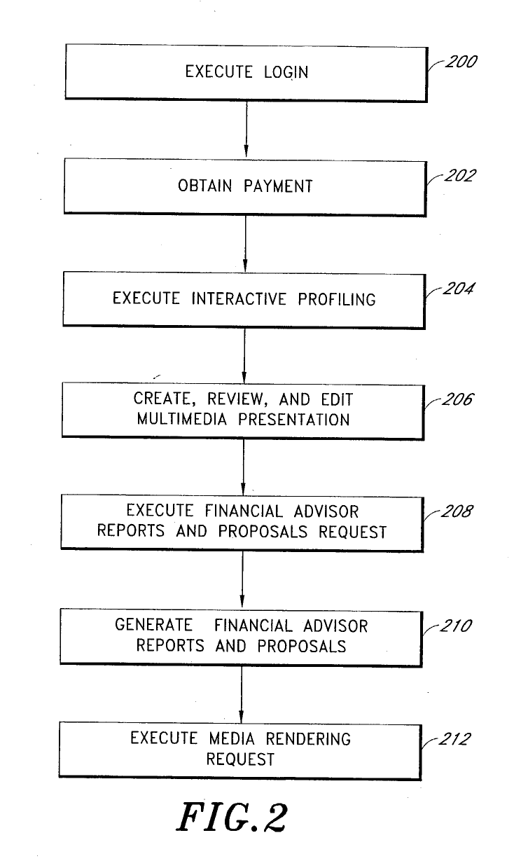

In one embodiment, as shown in FIG. 2, a login is executed at state 200, payment is obtained at state 202, interactive profiling is executed at state 204, a multimedia presentation creation, review, and edit is executed at state 206, a financial advisor reports and proposals request is executed at state 208, financial advisor reports and proposals are generated at state 210, and a media rendering request is executed at state 212.

In another embodiment, any suitable subset of these actions may be performed in any suitable order. In yet another embodiment, any suitable subset of these actions with additional suitable actions may be performed in any suitable order. For example only and not to limit the scope of the invention, in one instance, a financial advisor may access the system solely to review a multimedia presentation, to generate financial advisor reports and proposals, to view a video, or to render a video. In another instance, the financial advisor may access the system to review and edit the multimedia presentation and to render a video. Payments may, but need not be, obtained for any of the accesses and uses of the system.

Login

Referring to FIGS. 1 and 2, in one embodiment of the invention, at state 200, a financial advisor executes a login using the retirement visualizer software program that operates on the retirement visualizer system 100. If the login is successful, the retirement visualizer system 100 connects to the session manager 104 in a session. Any suitable method of login may be used.

Referring to FIGS. 1 and 2, in another embodiment, to execute a login at state 200, a DVD, or other suitable medium, is loaded into the retirement visualizer system 100. The retirement visualizer system 100 executes a login module in which a login is successful when an entered user identification and an entered password match an encrypted user identification and an encrypted password contained on the DVD, or other suitable medium. In another embodiment, a login is successful when an entered user identification and an entered password match an user identification and a password stored in any suitable location, including, but not limited to, the retirement visualizer system 100, the session manager 104, or other suitable computer system.

Referring to FIGS. 1 and 2, in another embodiment, after the retirement visualizer system 100 connects to the session manager 104, a user identification and password are passed from the retirement visualizer system 100 to the session manager 104. Among other suitable uses, the user identification and password are advantageously used for tracking the financial advisor's access of aspects of the retirement visualizer system 100.

Payment

Referring to FIGS. 1 and 2, in one embodiment of the invention, at state 202, the session manager 104 obtains authorization for payment from a third-party payment authorization system 102. If the authorization is successfully obtained, the session proceeds. Any suitable method of payment and authorization for such payment may be used. In another embodiment, the method of payment uses the financial advisor's credit card data. In another embodiment, if authorization is not successfully obtained, the retirement visualizer system 100 prompts the financial advisor for an alternative method of payment. In another embodiment, if the authorization is not successfully obtained, the session is terminated.

Referring to FIGS. 1 and 2, in other embodiments, other suitable methods of obtaining payment for the use of the system may be used. These payments may be obtained prior to, contemporaneous with, or subsequent to the financial advisor's use of the retirement visualizer system 100. These payments may be derived from one or more suitable factors, including, but not limited to, the number of accesses of the system, the process performed with the system, the period of time that the system is actually used, and a period of time for which use of the system is permitted. Interactive Profiling

Referring to FIGS. 1 and 2, in one embodiment, at state 204, retirement visualizer system 100 executes an interactive profiling session, wherein the investor is guided through an interactive profiling experience, and a psychographic profile of the investor is created.

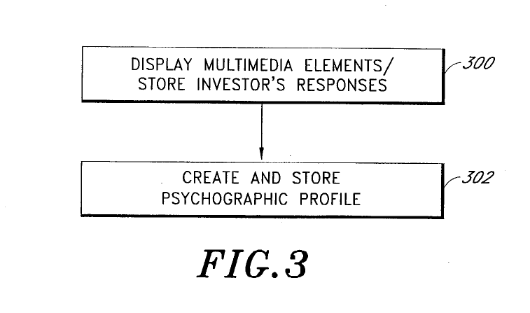

Referring to FIGS. 1, 2 and 3, in another embodiment, at state 300, the retirement visualizer system 100 executes an interactive profiling session by displaying one or more screens that comprise one or more multimedia elements and by storing the investor's responses to this display as part of the investor data. At state 302, the investor's responses to this display are used to create a psychographic profile of the investor that is stored as part of the investor data. The investor data, comprising the investor's responses to this display and the psychographic profile, is stored in a suitable location. In another embodiment, the investor data is stored on a hard drive of the retirement visualizer system 100.

For example only and not to limit the scope of the invention, in another embodiment of the invention, these multimedia elements may be any suitable elements, including, but not limited to, images or videos associated with the investor's preferred retirement. Preferably, the investor is shown images of possible locations of where the investor might live in retirement, or a new house the investor plans to build. For example, the investor is shown a beach house, a house in the country, or a downtown apartment. Preferably, the investor is shown the activities in which the investor may participate or places the investor might visit, which is particularly advantageous as it provides a concrete, visual image to an otherwise intangible aspiration. For example, the investor is shown a series of images of a beautifully landscaped golf course, an ocean sunset, the investor's children graduating from college, weekend baseball games with the investor's grandchildren, or a horseback ride. Preferably, the investor is shown the products or services that the investor may purchase or use in their retirement. For example, the investor is shown a classic automobile, or being on vacation to Hawaii with the investor's significant other. Throughout this process, the investor selects the more appealing multimedia elements, and this information is stored to create a psychographic profile of the investor. Through making these selections, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, through making these selections, the investor reviews concrete, visual images of his or her otherwise vague hopes and dreams for retirement. The investor emotionally connects with the vision provided by these concrete, visual images. Through assisting the investor as the investor makes these selections and reviews the multimedia elements, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. The focus of the financial advisor/investor discussion is not merely the financial products, but rather, the investor's self-understanding, preferred payoffs, and vision. With this client-centered approach, the financial advisor/investor relationship becomes a strong relationship based on confidence and trust. The investor is likely to refer the investor's friends to the financial advisor. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

In another embodiment, the interactive profiling session comprises creating a demographic profile of the investor. The demographic profile comprises demographic information about the investor. The demographic profile is stored as part of the investor data. In another embodiment, the interactive profiling session is dynamically altered in response to previous investor data of the investor. For example only and not to limit the scope of the invention, in one embodiment, an investor that has no children is not questioned regarding investing for a child's college tuition. Any suitable method may be used to dynamically alter an interactive profiling session. For example only and not to limit the scope of the invention, in another embodiment, the interactive profiling session is dynamically altered using a rules-based method.

Subconscious Aspects of the Psychographic Profile

Referring to FIG. 1, in another embodiment, the retirement visualizer system 100 obtains the investor data, comprising demographic profile and psychographic profile of the investor. The retirement visualizer system 100 transmits the investor data to the session manager 104, which stores the investor data in a database or other suitable storage device 106. The investor data is advantageously used to create or dynamically alter the future interactive profiling sessions of other investors to help determine the conscious and subconscious aspects of future investors' psychographic profile. Any suitable method may be used to dynamically alter an interactive profiling session. For example only and not to limit the scope of the invention, in another embodiment, the interactive profiling session is dynamically altered using a rules-based method.

For example only and not to limit the scope of the invention, in one embodiment, the multimedia objects that would motivate future investors are likely similar to the multimedia objects that motivated previous investors with similar demographic and psychographic profiles. By applying the investor data of the previous investors to the investor data of the future investor, the future interactive profiling session may be dynamically altered to show these multimedia objects that motivated the similar previous investors. Where the future investor was unaware of these motivating subconscious aspects of his or her psychographic profile, the future investor discovers subconscious aspects of his or her psychographic profile. Consequently, the future investor receives a clarified self-understanding. By focusing on the subconscious aspects of an investor's psychographic profile, the system increases the motivational effect above a system that merely focuses on an investor's conscious aspects of his or her psychographic profile.

In another embodiment, the psychographic data and demographic data is gathered from suitable sources other than previous interactive profiling sessions. This data is used to dynamically alter the future interactive profiling sessions. To dynamically alter the future interactive profiling sessions, this data may be, but need not be, used with the psychographic data and demographic data gathered from the previous interactive profiling sessions. The psychographic data and demographic data may be updated using any suitable method or system.

Multimedia Presentation Creation, Review, and Edit

Referring to FIGS. 1 and 2, in one embodiment, the retirement visualizer system 100 is advantageously used to create a multimedia presentation that presents a compelling vision of the investor's preferred retirement and that helps the investor gain a clarified self-understanding. At state 206, the multimedia presentation may be created, reviewed, and edited.

Referring to FIGS. 1 and 2, in another embodiment, the retirement visualizer system 100 uses the investor data to develop a psychographic profile of the investor and to select a combination of one or more video templates and one or more multimedia objects. Using this combination of templates and objects, the retirement visualizer system 100 creates a video script that comprises an index of pointers to the multimedia objects. The video script is used to review and edit the personalized multimedia presentation. The video script may be stored in any suitable location or medium. In one embodiment, the retirement visualizer system 100 stores the video script on a hard drive of the retirement visualizer system 100. The multimedia objects may be stored in any suitable location or medium. In one embodiment, the multimedia objects are stored on a DVD. The video templates may be stored in any suitable location or medium. In one embodiment, the video templates are stored on a DVD. In another embodiment, the sources of multimedia objects or video templates are supplemented from the downloading of new multimedia objects or of video templates to a suitable location or medium. The downloading may be induced in any suitable manner, including, but not limited to, a user request, or according to a schedule set within a computer system. For example only and not to limit the scope of the invention, in an embodiment where the multimedia objects are stored on a DVD, new multimedia objects are downloaded by the system to a hard drive located on retirement visualizer system 100.

Referring to FIGS. 1 and 2, in another embodiment, at state 206, the retirement visualizer system 100 comprises a multimedia player and a script editor, which are used to review and edit the multimedia presentation. The financial advisor uses the retirement visualizer system 100 to access the video script from its storage location and displays the multimedia objects. Using the script editor, the financial advisor modifies the video script by selecting multimedia objects. Upon completion of the modifications, the retirement visualizer system 100 stores a final multimedia presentation that comprises the video script and the multimedia objects. In one embodiment, the financial advisor selects the multimedia objects from pull down menus. In one embodiment, the multimedia objects include investor-supplied images. As known by those skilled in the art, images may be created in many suitable ways and may be in one of many suitable formats. In one embodiment, the investor-supplied images comprise JPEG images scanned in using a scanner attached to the retirement visualizer system 100. As is known by those skilled in the art, the investor-supplied images may be stored in many suitable locations. In one embodiment, the retirement visualizer system 100 stores the investor-supplied images on a hard drive of the retirement visualizer system 100.

Referring to FIGS. 1 and 2, in one embodiment, upon completion of the modifications, the financial advisor uses the retirement visualizer system 100 to review the final multimedia presentation with the investor at state 206.

Through reviewing and editing the multimedia presentation, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, through reviewing and editing the multimedia presentation, the investor reviews concrete, visual images of his or her otherwise vague hopes and dreams for retirement. The investor emotionally connects with the vision provided by these concrete, visual images. Through reviewing and editing the multimedia presentation, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. The focus of the financial advisor/investor discussion is not merely the financial products, but rather, the investor's self-understanding, preferred payoffs, and vision. With this client-centered approach, the financial advisor/investor relationship becomes a strong relationship based on confidence and trust. The investor is likely to refer the investor's friends to the financial advisor. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

In another embodiment, any suitable method and system of creating, reviewing, and editing a multimedia presentation may be used in connection with the embodiments of the invention.

Financial Advisor Reports and Proposals Request

Referring to FIG. 2, in one embodiment of the invention, at state 208, the retirement visualizer system 100 executes a financial advisor reports and proposals request, comprising the display of one or more screens that contain one or more questions. The financial advisor's responses to the financial advisor reports and proposals request, or financial advisor response data, are used for any suitable purposes associated with preparing reports or proposals. In another embodiment, the financial advisor response data is used to select a proposal template for creating a proposal for financial products or services to be provided to the investor. In another embodiment, the proposal template comprises a standard proposal template without financial advisor specifics.

In another embodiment, the proposal template comprises a standard template with integrated financial advisor specifics. The proposal template is preferably customizable, wherein the financial advisor or a computer system may select one or more elements suitable for a proposal, including, but not limited to the name of investor, the age of the investor, financial products or services, the prices of the products or services, and multimedia elements from the multimedia presentation. Through the use of the system, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. By using a customizable proposal template, the financial advisor may create a proposal for products or services that would be appropriate for the investor, according to the investor's self-understanding, preferred payoffs, and vision.

Referring to FIGS. 1 and 2, for example only and not to limit the scope of the invention, in another embodiment, in executing the financial advisor reports and proposals request, the retirement visualization system 100 prompts the financial advisor to enter the name and age of the investor, certain products or services, and incorporates those responses with images from the multimedia presentation into a financial advisor report, comprising a proposal to be reviewed by the financial advisor and the investor.

Referring to FIGS. 1 and 2, in another embodiment, the financial advisor response data may be stored in any suitable location or medium. In one embodiment, the retirement visualizer system 100 stores the financial advisor response data on a hard drive of the retirement visualizer system 100.

Referring to FIGS. 1 and 2, in another embodiment, in executing the financial advisor reports and proposals request, the financial advisor may choose from multiple proposal templates. In another embodiment, the proposal template is supplied with the initial retirement visualizer system 100. In another embodiment, the proposal template is added to the retirement visualizer system 100 by the financial advisor.

Generating Financial Advisor Reports and Proposals

Referring to FIGS. 1 and 2, in one embodiment, at state 210, the retirement visualizer system 100 generates one or more reports.

In another embodiment, a report discusses the investor's psychographic profile. Through reviewing this report, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, through reviewing this report, the investor reviews concrete, visual images of his or her otherwise vague hopes and dreams for retirement. The investor emotionally connects with the vision provided by these concrete, visual images. Through reviewing this report, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. The focus of the financial advisor/investor discussion is not merely the financial products, but rather, the investor's self-understanding, preferred payoffs, and vision. With this client-centered approach, the financial advisor/investor relationship becomes a strong relationship based on confidence and trust. The investor is likely to refer the investor's friends to the financial advisor. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

In another embodiment, a report comprises a proposal for products or services recommended to help the investor turn the investor's vision of the investor's preferred retirement into reality. Through reviewing this report, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, through reviewing this report, the investor reviews concrete, visual images of his or her otherwise vague hopes and dreams for retirement. The investor emotionally connects with the vision provided by these concrete, visual images. Through reviewing this report, the financial advisor learns the aspects of the investor's self-understanding, the investor's preferred tangible and intangible payoffs, and the investor's vision. With this shared understanding of the investor's self-understanding, preferred payoffs, and vision, the financial advisor can better advise the investor as to what products or services would be appropriate for the investor, according to the investor's self-understanding, preferred payoffs, and vision. The focus of the financial advisor/investor discussion is not merely the financial products, but rather, the investor's self-understanding, preferred payoffs, and vision. With this client-centered approach, the financial advisor/investor relationship becomes a strong relationship based on confidence and trust. The investor is likely to refer the investor's friends to the financial advisor. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

In another embodiment, a report lists aspects of the investor's retirement that need to be priced. This report acts as a checklist for what the investor needs to research. For example only and not to limit the scope of the invention, an investor that wants to travel to see the pyramids in Egypt would want to research the costs associated with that trip.

Video Rendering Request

Referring to FIGS. 1 and 2, at state 212, the retirement visualizer system executes a video rendering request, in which the financial advisor may request one or more suitable works to be rendered, including, but not limited to, a video, a customized screen saver, a customized photo cube, or photo album. Through reviewing these works, the investor discovers the unknown aspects of his or her psychographic profile and clarifies the known aspects of his or her psychographic profile; and, consequently, the investor gains a clarified self-understanding. With this clarified self-understanding, the investor is able to clarify the tangible and intangible payoffs that the investor wants from his or her preferred retirement. Additionally, through reviewing these works, the investor reviews concrete, visual images of his or her otherwise vague hopes and dreams for retirement. The investor emotionally connects with the vision provided by these concrete, visual images. With a clarified self-understanding, knowledge of the investor's preferred payoffs, and a vision of the investor's preferred retirement, the investor assesses the potential benefits of the financial advisor's products or services, and determines that the financial advisor's products or services will deliver the investor's preferred payoffs. Consequently, the investor is motivated to purchase or use the appropriate financial products or services offered by the financial advisor.

Referring to FIGS. 1 and 2, for example only and not to limit the scope of the invention, in another embodiment, the retirement visualizer system 100 transmits the final video script, the financial advisor response data, and any investor-supplied images to the session manager 104. Transmissions may be, but need not be, encrypted. The session manager 104 passes the video script and the investor-supplied images to the video producing and rendering system 108 for final video rendering of the multimedia presentation. The video producing and rendering system 108 accesses a source of multimedia content 110 in rendering the multimedia presentation, which allows the video producing and rendering system to render the multimedia presentation without requiring the transmission of the images other than the investor-supplied images. The multimedia presentations may be rendered in any suitable format, including, but not limited to, CD-ROM, VHS, or DVD. In another embodiment, multimedia content from the multimedia presentation is used to create any one or more suitable works, including, but not limited to, a customized screen saver, a customized photo cube, or photo album. The multimedia presentations or works may be transmitted and created via any suitable method. In another embodiment, the retirement visualizer system 100 is used to request any suitable combination of a rendered multimedia presentation, and suitable works. The rendered multimedia presentation and suitable works may be delivered to the investor.

Multiple Scenarios

In one embodiment of the invention, the financial advisor prepares multiple proposals based upon different scenarios for the investor. For example only and not to limit the scope of the invention, the proposals may vary according to age of retirement, or may vary according to the preferred payoffs. With a clarified self-understanding, knowledge of the investor's preferred payoffs, and a vision of the investor's preferred retirement, the investor assesses the potential benefits of the multiple proposals, and is motivated to purchase or use the appropriate proposal offered by the financial advisor.

Investor Data Reports and Financial Advisor Data Reports

Referring to FIG. 1, in one embodiment, the session manager 104 stores the financial advisor response data and investor data from which statistical reports may be generated in standard and ad hoc formats. In one situation, the statistical reports are advantageously used to make decisions regarding the marketing of existing products and services, decisions regarding the development of new products and services.

Functionality Enablement

Referring to FIG. 1, in another embodiment, at least a portion of the retirement visualizer software program is encrypted or disabled. The session manager 104 transmits a key to the retirement visualizer system 100 to enable functionality in the retirement visualizer software program. Any suitable set or subset of the retirement visualizer software program functionality may be enabled using this method.

Referring to FIG. 1, for example only and not to limit the scope of the invention, in another embodiment, the session manager 104 passes an encrypted key to the retirement visualizer system 100, directing the retirement visualizer system 100 to execute functionality associated with the multimedia presentation creation, review, and edit. In another embodiment, the session manager 104 passes an encrypted key to the retirement visualizer system 100, directing retirement visualizer system 100 to execute functionality associated with interactive profiling. In another embodiment, the session manager 104 passes an encrypted key to the retirement visualizer system 100, directing retirement visualizer system 100 to execute functionality associated with the financial advisor reports.

Referring to FIG. 1, for example only and not to limit the scope of the invention, in another embodiment, the session manager 104 transmits an encrypted key to the retirement visualizer system 100 to enable functionality in the retirement visualizer software program. Encrypted keys may be based on one or more suitable items. In one embodiment, the encrypted key is based on at least one or more of the following: information from the financial advisor's computer, the financial advisor's IP address, a date and time, an investor identification number, information about the investor, a financial advisor identification number, or information about the financial advisor.

Among other advantages, the use of keys to enable functionality helps to ensure that portions of the retirement visualizer software program are not run out of sequence and helps to ensure that portions of the retirement visualizer software program are not run without payment.

Software Installation and Updates

Referring to FIG. 1, in one embodiment, the retirement visualization system 100 operates a software installation routine. In another embodiment, the software installation routine gathers financial advisor identification information, financial advisor's credit card data, data relating to financial advisor reports and proposals requests, and data relating to proposal templates. In one embodiment, the software installation routine writes all software module code, data relating to interactive profiling sessions, and data it gathers on a hard disk of the retirement visualization system. In one embodiment, the software installation routine does not install multimedia objects on a hard disk of the retirement visualization system 100, but rather remains on another suitable medium, including, but not limited to, an installation CD or DVD, or a remote multimedia data source.

Referring to FIG. 1, in one embodiment, the session manager 104 sends updates to the retirement visualizer system 100 to update any aspect of the embodiment that exists on the retirement visualizer system 100. In one embodiment, the session manager 104 updates the interactive profiling sessions, the financial advisor proposal templates, the multimedia objects, and the retirement visualizer software program.

Modules and Functionality

Referring to FIG. 1, the functionality described herein may be implemented in whole or in part using the retirement visualization system 100, may be implemented in whole or in part using the session manager 104, or may be implemented in whole or in part using one or more suitable computer systems.

Referring to FIGS. 1 and 2, for example only and not to limit the scope of the invention, in another embodiment, the retirement visualizer system 100 operates code to execute the login of the financial advisor at state 200, to execute the interactive profiling session at state 204, to execute the multimedia presentation creation at state 206, to execute the multimedia presentation edit at state 206, to execute the multimedia presentation review at state 206, to execute the financial advisor reports and proposals request at state 208, to generate the financial advisor reports and proposals at state 210, and to execute a video rendering request at state 212. The session manager 104 obtains payment authorization at state 202, maintains the financial advisor response data and the investor data in a database or other suitable storage device 106, prepares reports based on the financial advisor response data and the investor data, and passes the video script and the investor-supplied images to the video producing and rendering system 108 for final video rendering of the multimedia presentation.

Referring to FIG. 1, in another embodiment, the retirement visualizer system 100 may perform suitable functions that are described herein as being performed by the financial advisor. For example only and not to limit the scope of the invention, in another embodiment, the retirement visualizer system 100 help to provide a vision of the investor's preferred retirement, and the financial advisor proposes a plan and helps the investor to implement that plan. In other embodiments, the retirement visualizer system 100 may assist the investor to create a plan and implement that plan.

For example only and not to limit the scope of the invention, in another embodiment, functionality described herein may be implemented in whole or in part using one or more suitable computer systems. In another embodiment, the system may be accessed and used via an Internet browser or other suitable system.

Although this invention has been described in terms of certain preferred embodiments, other embodiments that are apparent to those of ordinary skill in the art, including embodiments which do not provide all of the benefits and features set forth herein, are also within the scope of this invention. Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

What is claimed is:

1. A method for dynamically displaying suggested video clips representing suggested events in a person's retirement to allow the person to create a video representation of the person's ideal retirement and thereby motivate the person to take appropriate action to make that ideal retirement a reality, the method comprising:
displaying video clips of typical retirement activities, including a golfer walking along a beautifully landscaped golf course;
selecting at least one of the displayed video clips;
accessing a database, the database comprising:
data identifying the displayed video clips;
data identifying previously undisplayed video clips, including a couple walking along an ocean at sunset; and
data identifying associations between the displayed video clips with the undisplayed video clips, including an association between the golfer video clip and the ocean video clip, wherein the associations are sufficient to indicate that, if a person selects a first displayed video clip as being desirable for retirement, the person may find a second previously undisplayed video clip as being desirable for retirement;
using the selected video clips and the database to identify at least one of the previously undisplayed video clips;
displaying the identified previously undisplayed video clips;
selecting at least one of the identified previously undisplayed video clips; and
rendering the selected video clips in at least one machine-readable format, including DVD format.

2. A method for dynamically displaying suggested video clips representing suggested events in a person's retirement to allow the person to create a video representation of the person's ideal retirement and thereby motivate the person to take appropriate action to make that ideal retirement a reality, the method comprising:
displaying video clips of typical retirement activities, selecting at least one of the displayed video clips;
accessing a database, the database comprising:
data identifying the displayed video clips;
data identifying previously undisplayed video clips, with typical retirement activities; and
data identifying associations between the displayed video clips with the undisplayed video clips, including an association between the displayed clip and an undisplayed clip, wherein the associations are sufficient to indicate that, if a person selects a first displayed video clip as being desirable for retirement, the person may find a second previously undisplayed video clip as being desirable for retirement;
using the selected video clips and the database to identify at least one of the previously undisplayed video clips;
displaying the identified previously undisplayed video clips;
selecting at least one of the identified previously undisplayed video clips; and
rendering the selected video clips in at least one machine-readable format, including DVD format.

3. A method in a computer system for enhancing a person's self-understanding, visualization, and motivation, the method comprising:
creating a database for associating multimedia screens representative of a preferred future, the creating comprising:
storing first data identifying a first set of one or more multimedia screens;
storing second data identifying a second set of one or more multimedia screens; and
storing third data identifying one or more associations, the one or more associations associating at least one subset of the first set of screens and at least one subset of the second set of screens;
wherein the one or more associations are sufficient, upon identification of a screen in the first set of screens as representing a preferred future, to identify the at least one subset of the second set of screens and wherein the at least one subset of the second set of screens are displayable for selecting as a preferred future;
displaying one or more screens of the first set of multimedia screens for a person to review and to select as representing a preferred future;
receiving fourth data identifying one or more first selected screens that the person selected;
identifying one or more screens that are associated with the first selected screens according to the third data identifying one or more associations and the fourth data identifying first selected screens; and
displaying the one or more screens that are associated with the first selected screens.

4. The method of claim 3 further comprising:
receiving fifth data identifying one or more second selected screens that the person selected from the set of the one or more screens that are associated with the first selected screens; and
identifying one or more screens that are associated with the second selected screens according to the third data identifying one or more associations and the fifth data identifying second selected screens.

5. The method of claim 4 further comprising:
creating a psychographic profile, the creating comprising:
storing the fourth data identifying one or more first selected screens;
storing the fifth data identifying one or more second selected screens;
storing sixth data identifying the person; and
storing seventh data associating the fourth data with the sixth data and associating the fifth data with the sixth data.

6. The method of claim 5 further comprising:
rendering the one or more first selected screens and the one or more second selected screens on a DVD.

7. A computer system for enhancing a person's self-understanding, visualization, and motivation, the computer system comprising:
a server computer system, comprising:
a computer-readable medium storing first data identifying a first set of one or more multimedia screens, storing second data identifying a second set of one or more multimedia screens; and storing third data identifying one or more associations among one or more screens in the first set of screens and one or more screens in the second set of screens;
a client computer system coupled to the server computer system, the client computer system being configured to execute a profiling session, the profiling session comprising:
using the first data to display a first set of one or more displayed multimedia screens for selection as a preferred future;
receiving fourth data identifying a first set of one or more selected multimedia screens;
using the first data, second data, third data, and fourth data to display a second set of one or more displayed multimedia screens for selection as a preferred future;
receiving fifth data identifying a second set of one or more selected multimedia screens; and
transmitting the fourth data and the fifth data to the server computer system for storage on the computer-readable medium.

8. The computer system of claim 7 further comprising:
a computer system coupled to the server computer system, configured to receive the fourth data and the fifth data from server computer system, and configured to use the fourth data and fifth data to render one or more of the first set of selected multimedia screens and of the second set of selected multimedia screens.
